(19) United States
(12) Patent Application Publication
(10) Pub. No.: US 2007/0069541 A1
(43) Pub. Date: Mar. 29, 2007

(54) MODULAR FLOOR CONSOLE

(75) Inventors: Alan Sturt, West Bloomfield, MI (US); James Mulvihill, Royal Oak, MI (US); Todd L. DePue, Brighton, MI (US); Thomas S. Hicks, Livonia, MI (US); Won-Tai Kim, Macomb, MI (US); David Joseph Cauvin, Brighton, MI (US)

Correspondence Address: Bruce E. Harang, PO BOX 872735, VANCOUVER, WA, 98687-2735, US

(73) Assignee: LEAR CORPORATION, Southfield, MI (US)

(21) Appl. No.: 10/904,523

(22) Filed: Aug. 25, 2005

(51) Int. Cl. B60R 7/04

(52) U.S. Cl. 296/24.34

(57) ABSTRACT

A modular floor storage system that may be easily and quickly mounted, dismounted, and locked into position without the need for elaborate mounting track systems. Further the modular floor storage system may be configured in many ways by the user and located in several locations within the vehicle. Electrical connection may also be provided allowing power to be supplied for purposes such as battery-charging, lighting and the incorporation of cooling or heating capacity to the storage system.

### BACKGROUND OF THE INVENTION

1. Field of the Invention

The present invention generally relates to a console for storing or containing various items in a vehicle. More particularly, the present invention relates to a reconfigurable, modular floor console having at least one, preferably more than one storage unit easily mounted and dismounted, and further having an easily operable latching mechanism.

2. Description of the Related Art

Various types of storage containers are well known for use in a vehicle including as a center console. Vehicle storage containers and organizers continue to be very popular in all types of vehicles. One reason for the increase in popularity is that storage containers afford a vehicle driver or passenger increased organization and utilization of interior space. Additionally, a storage console can add to driver and passenger convenience and comfort since they can hold beverage cups, cans and bottles as well as numerous other types of objects, equipment, tools, gear, and items. However, despite being aware of the above, vehicle designers and manufacturers continue to provide very simple and basic storage compartments with no option to reconfigure them by the manufacturer or the consumer.

It is common for a vehicle to have a single storage compartment, typically located in a center console positioned on the floor, and having a single door for accessing the interior of the storage container. Thus, a driver or passenger seeking a particular item must use one entry into a single compartment storage container where items are stored one on top of another with little organization.

In addition, the consumer has no means of changing the storage compartment configuration, size, entry points, or number of storage units. The consumer also has neither the option of mounting the storage units in the rear cargo area of a vehicle such as a van, minivan, SUV, or the trunk of a car, nor the ability to provide power to the storage unit such that a refrigerator or heating unit can be mounted within the vehicle compartment.

For example, U.S. Pat. No. 6,135,529 issued Oct. 24, 2000 to De Angelis et al. teaches a floor console having at least one storage unit mounted and movable on a pair of tracks mounted on the vehicle floor between the seats.

U.S. Pat. No. 6,726,267 issued Apr. 27, 2004 to Kim et al. teaches a two-stacked unit floor console system wherein the two units move together or independently on tracks.

U.S. Patent Application Publication No. 2002/0140246 issued Oct. 3, 2002 to Worrell et al. teaches a storage unit mountable to a removable seat floor mounts after the removable seat has been removed from the vehicle.

U.S. Patent Application Publication No. 2003/0057724 issued Mar. 27, 2003 to Inagaki et al. teaches an in-floor storage system having multiple storage bins covered by a multi-hinged lid/cargo floor.

U.S. Patent Application Publication No. 2003/0122392 issued Jul. 3, 2003 to Larsen et al. teaches a storage unit mounted on a base unit and having at least one armrest moveable over the storage unit.

U.S. Patent Application Publication No. 2003/0127878 issued Jul. 10, 2003 to Gort et al. teaches an overhead track attachment unit to which module units may be hung to provide storage and other features within a vehicle compartment.

U.S. Patent Application Publication No. 2003/0155786 issued Aug. 21, 2003 to Kim et al. teaches a two-stacked unit floor console system wherein the two units move together or independently on tracks.

U.S. Patent Application Publication No. 2003/0234550 issued Dec. 25, 2003 to Brooks et al. teaches a two-piece console mounted and moveable on a pair of tracks within a vehicle passenger compartment.

### DISCLOSURE OF THE INVENTION

The present invention provides advantages and alternatives over the prior art by providing a modular, multiple unit, floor console system which allows for the consumer to reconfigure the storage area within a vehicle passenger and/or cargo compartment.

According to a further aspect of the present invention, there is provided a modular floor storage system that may be easily and quickly mounted, dismounted, and locked into position.

According to yet another aspect of the present invention there is provided the option of providing electrical connection between the storage unit and the vehicle electrical system.

According to a yet further aspect of the present invention, there is provided a means of distributing heated/cooled air to the rearmost module.

According to still another aspect of the present invention a module can be repositioned to a remote location.

According to another aspect of the present invention, there is provided a modular floor console providing user configurable storage detachably mountable within a vehicle comprising; at least one storage unit comprising a bin having a hinged lid mounted thereon, said bin further having a device for detachably latching said bin to a surface of a vehicle interior; thereby providing a removable, configurable modular floor storage console.

According to yet another aspect of the present invention, there is provided a modular floor console providing user configurable storage detachably mountable within a vehicle comprising; at least one storage unit comprising a bin having a hinged lid mounted thereon, said bin further having a device for detachably latching said bin to a surface of a vehicle interior; and an end storage unit comprising a bin, said end storage unit further having located on one exterior end at least one interlocking prong and further having a device for detachably latching said end storage unit to a surface of a vehicle interior as well as activating the detachably latching device located on said at least one storage unit; thereby providing a removable, configurable modular floor storage console.

According to still another aspect of the present invention, there is provided a modular floor console providing user configurable storage detachably mountable within a vehicle comprising; at least one storage unit comprising a bin having a hinged lid mounted thereon, said bin further having a device for detachably latching said bin to a surface of a vehicle interior; and providing electrical connection through said at least one interlocking prong and said at least one complimentary interlocking channel; thereby providing an electrically enabled, removable, configurable modular floor storage console.

According to still another aspect of the present invention, there is provided a modular floor console providing user configurable storage detachably mountable within a vehicle comprising; at least one storage unit comprising a bin having a hinged lid mounted thereon, said bin further having located on one exterior end at least one interlocking prong and having located on the exterior end opposite at least one complimentary interlocking channel, said bin further having a device for detachably latching said bin to a surface of a vehicle interior; an end storage unit comprising a bin having access through a end wall and a top surface adaptable to holding beverage containers therein, said end storage unit further having located on one exterior end at least one interlocking prong and further having a device for detachably latching said end storage unit to a surface of a vehicle interior as well as activating the detachably latching device located on said at least one storage unit; and providing electrical connection through said at least one interlocking prong and said at least one complimentary interlocking channel; thereby providing a removable, configurable modular floor storage console.

According to yet still another aspect of the present invention, there is provided a modular floor console providing user configurable storage detachably mountable within a vehicle comprising; a console mountable to a vehicle floor and having a storage unit mounting area; at least one storage unit comprising a bin having a hinged lid mounted thereon, said bin further having a device for detachably latching said bin in the storage unit mounting area of said console; thereby providing a removable, configurable modular floor storage console.

According to yet another aspect of the present invention, there is provided a modular floor console providing user configurable storage detachably mountable within a vehicle comprising; a console mountable to a vehicle floor and having an adjustable size storage unit mounting area; at least one storage unit comprising a bin having a hinged lid mounted thereon, said bin further having a device for detachably latching said bin in the storage unit mounting area of said console; thereby providing a removable, configurable modular floor storage console.

The present invention thus advantageously provides a modular floor storage system configurable by the vehicle user to provide the storage configuration and features needed by said vehicle user.

### BRIEF DESCRIPTION OF THE DRAWINGS

FIG. 1 shows a perspective view of three interlocked storage units of the present invention including interlocking prongs and unit floor locking device.

FIG. 2 shows a perspective view of the three interlocked storage units of the present invention shown in FIG. 1 from the opposite end showing the complimentary mating interlocking channels.

FIG. 3 shows a perspective view of three interlocked storage unit and an end storage unit of the present invention.

FIG. 4 show a partial perspective view of a storage unit of the present invention showing an alternative system to lock the unit to the vehicle floor.

FIG. 5 shows a partial perspective view of the rear cargo area of a vehicle with a docking station adaptable to receive the modular floor storage system of the present invention.

FIG. 6 shows a perspective view of another preferred embodiment of the present invention where the interlocked storage units are mounted in a console base unit.

FIG. 7 shows a perspective view of the embodiment of the present invention of FIG. 6 having a single storage unit mounted in the console base unit.

FIG. 8 shows a cross section plan view of unit latching apparatus mounted in a storage unit and attaching the storage unit to the console base unit.

FIG. 9 shows a perspective view of the latching mechanism allowing a storage unit to be latched and unlatched on both sides by a single activation handle.

FIG. 10 shows a partial interior perspective view of a storage unit latching apparatus activating handle mounted therein.

FIG. 11 shows another embodiment of the present invention utilizing a formed mounting strip fixedly attached to a vehicle floor.

FIG. 12 shows a partial section perspective view of one of the mounting points of the mounting strip of FIG. 11.

FIG. 13 shows a partial side plan view of one of the mounting points of the mounting strip of FIG. 11

FIG. 14 shows a perspective end view of an embodiment of a storage unit for mounting to the mounting strip of FIG. 11 having a mounting apparatus activating handle moveably mounted in the end of said storage unit.

FIG. 15 shows a partial cross section plan view of the storage unit of FIG. 14 and the mounting apparatus thereof.

FIG. 16 shows a partial cross section plan view of the storage unit for mounting in the mounting strip of FIG. 11 showing the mounting apparatus including the activating handle.

FIG. 17 shows a perspective view of another embodiment of a base unit capable of mounting at least one storage unit, also shown are two storage units mountable thereon.

FIG. 18 shows a base unit of the present invention incorporating electrical power strips therein.

FIG. 19 shows a partial cross section plan view of the base unit of FIG. 18 showing the power strip mounted therein.

Finally, FIG. 20 shows a partial cross section plan view of a storage unit having an electrical connector capable of insertion into the power strip of the base unit of FIG. 18.

### DESCRIPTION OF THE PREFERRED EMBODIMENTS OF THE INVENTION

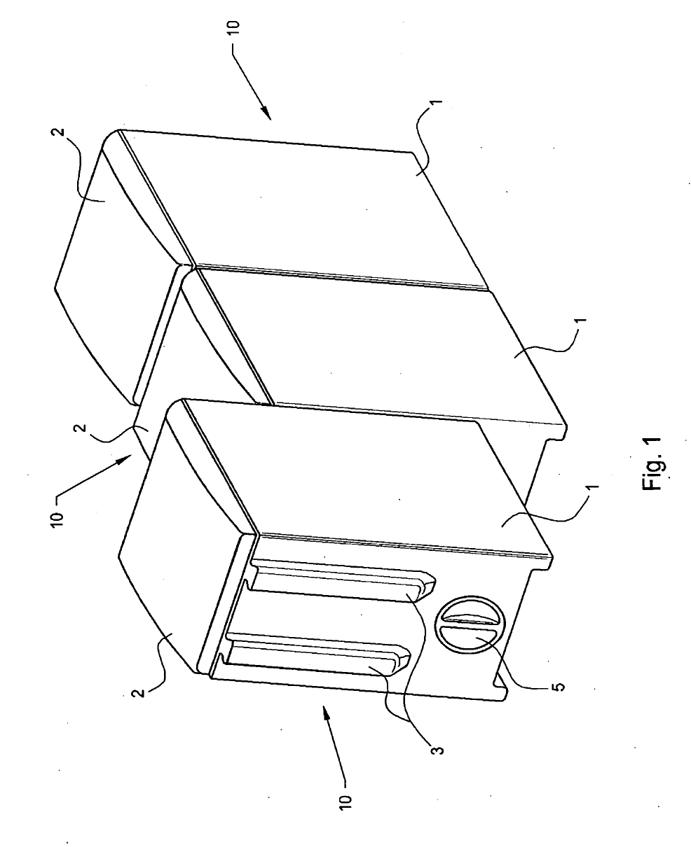

Reference will now be made to the drawings, wherein to the extent possible like reference numerals are utilized to designate like components throughout the various views. Referring to FIG. 1, which presents a perspective view of three storage modules 10 of the present invention, each storage module comprising a bin 1 having a lid 2 attached thereto by a hinge device such that said lid 2 may be opened to allow access to the interior of bin 1 or closed to contain the contents within bin 1.

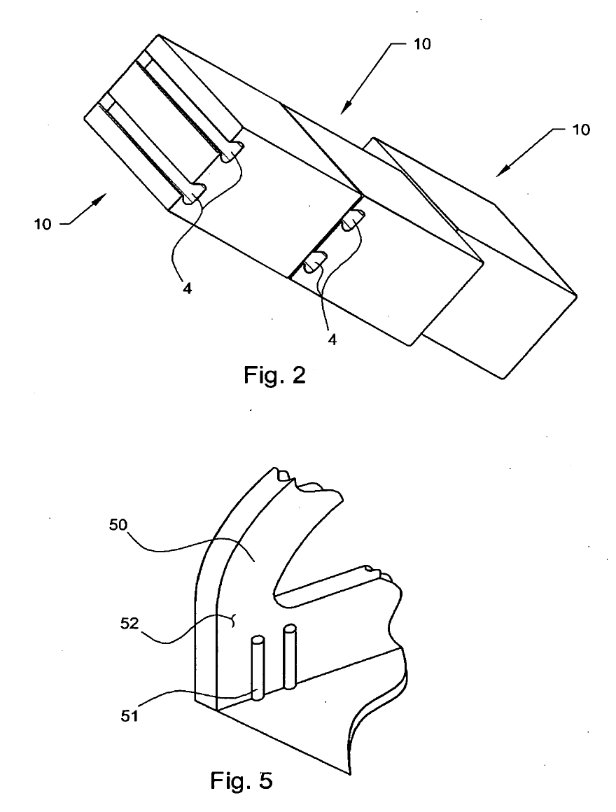

As further shown in FIG. 1 each storage module 10 has a pair of prongs 3 on one end of storage module 10 allowing the interlocking of storage modules 10 to one another by mating with a complimentary pair of mating channels 4 (FIG. 2) located on the storage module 10 end opposite that having said pair of prongs 3. As also shown is latching device 5 used to latch the storage modules 10 to the vehicle floor.

Referring now to FIG. 2, there is shown a perspective view of the three storage modules of FIG. 1 showing the complimentary mounting channels 4.

Turning now to FIG. 3, there is shown another perspective view of three storage modules 10, each comprising a bin 1 having a lid 2 and latching device 5 to which an end storage module 20 is interlocked to one end of the set of three storage modules 10. Said end storage module 20 comprising a bin 21 having a storage area accessed by storage area opening 22 and further having at least one beverage container recess 23 on the top surface of bin 21. Also shown is latching activation handle 24 which allows easy attachment to and detachment from the interior of the vehicle.

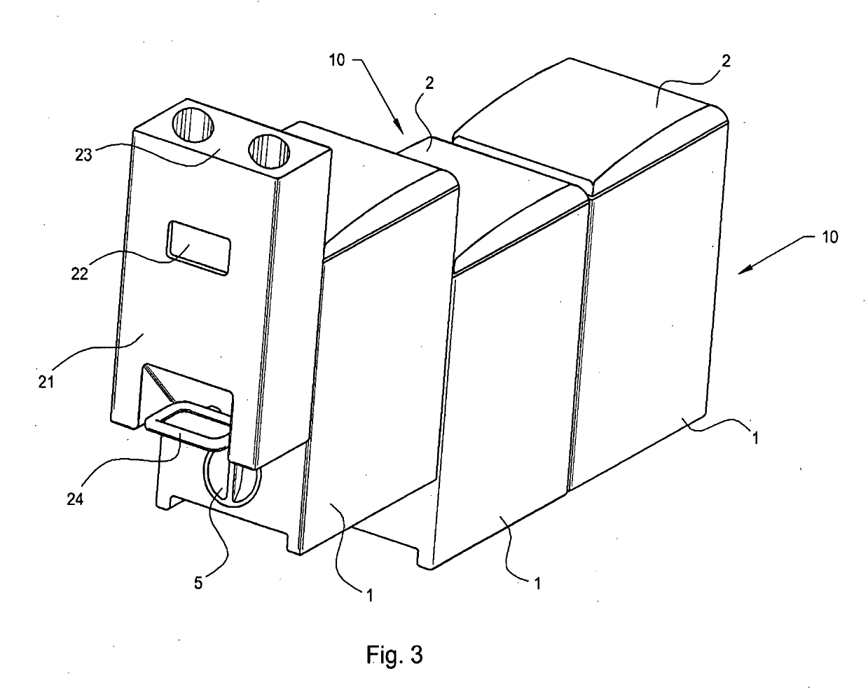

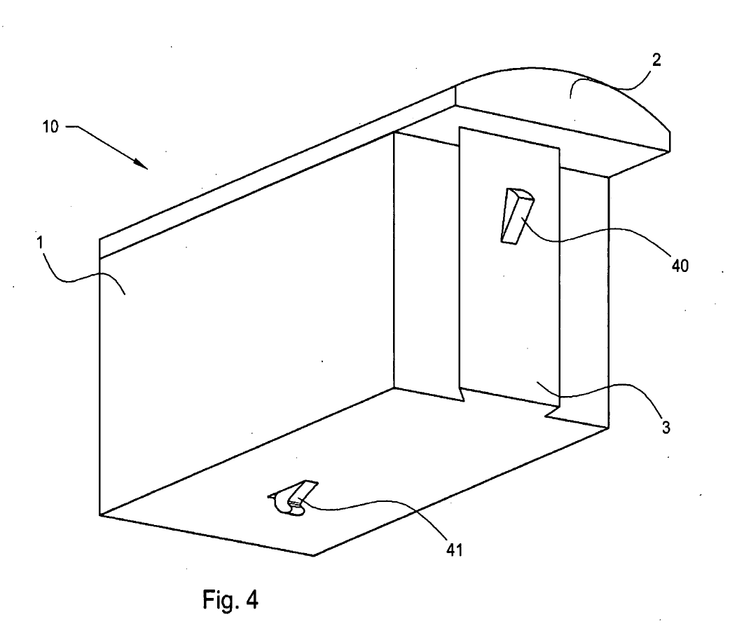

Referring now to FIG. 4, there is shown a partial perspective view of one storage module 10 having a bin 1 with a lid 2 and a single mating interlocking prong 3. Located on interlocking prong 3 is a latching engagement lever 40 which activates the latch 41 to provide attachment to the vehicle interior.

Referring now to FIG. 5 there is shown a partial perspective view of the cargo area 50 of a vehicle having an interior panel 52 in which is mounted a docking station 51 being capable of receiving the interlocking prongs 3 of modular storage modules 10 (FIGS. 1 and 4).

Referring to FIG. 6 there is shown a perspective view of another preferred embodiment of the present invention comprising a console base unit 60 into which a plurality of storage units 10 and an end storage unit 20 may be detachably mounted. The storage units 10 having a bin 1 with a lid 2 moveably mounted to bin 1 by a pair of hinges 25, and also having a storage unit 10 lid latching handle 26.

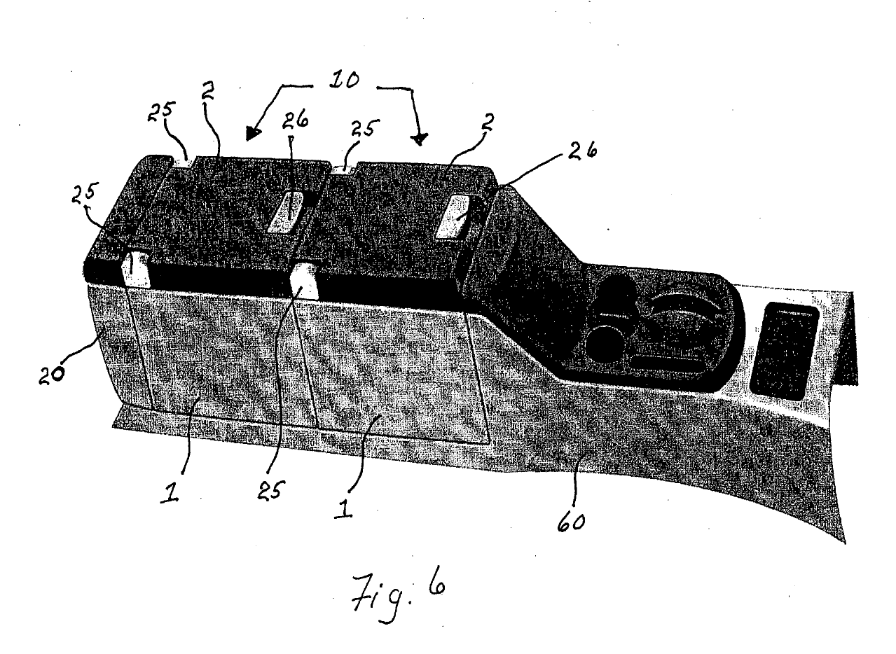

Referring now to FIG. 7 there is shown the preferred embodiment of the present invention as shown in FIG. 6 where only one storage bin 10 and one end storage unit 20 are attached to the console 60. Again there is shown a bin 1 having a lid 2 attached by a pair of hinges 25 and further having a lid latching handle 26. While FIG. 7 shows the storage bin 10 and end storage unit 20 being mounted at the front portion of the console 60 storage mounting area 67, it is to be understood that the bins may also be stored at the rear of console 60 storage mounting area 67. Such a configuration allows larger items such as purses and wallets, for example, to be stored safely in the open area between the front of console 60 and the front of storage bin 10. It is also to be understood that the storage unit mounting area may be preconfigured to have storage options such as beverage container holders therein which may be used when no storage bin 10 is mounted thereover. Alternatively, an organizer tray can be removably mounted to the said storage unit mounting area to provide these options.

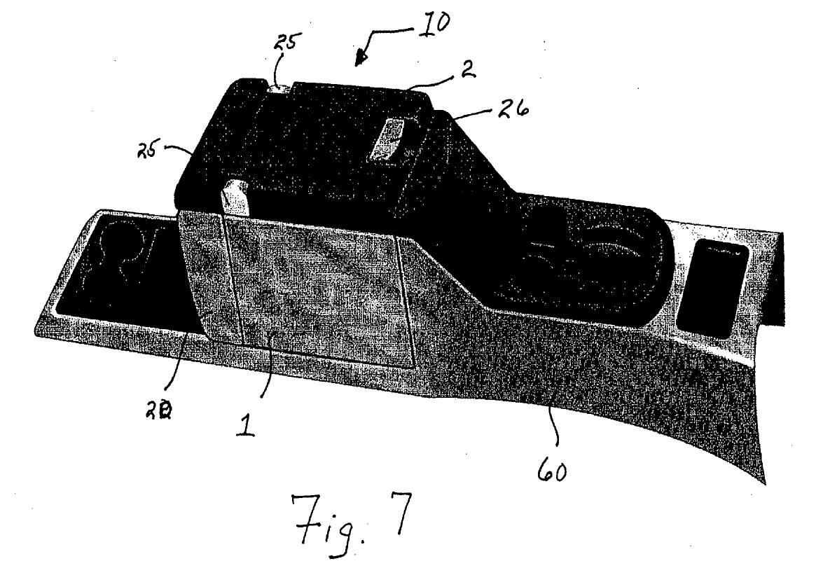

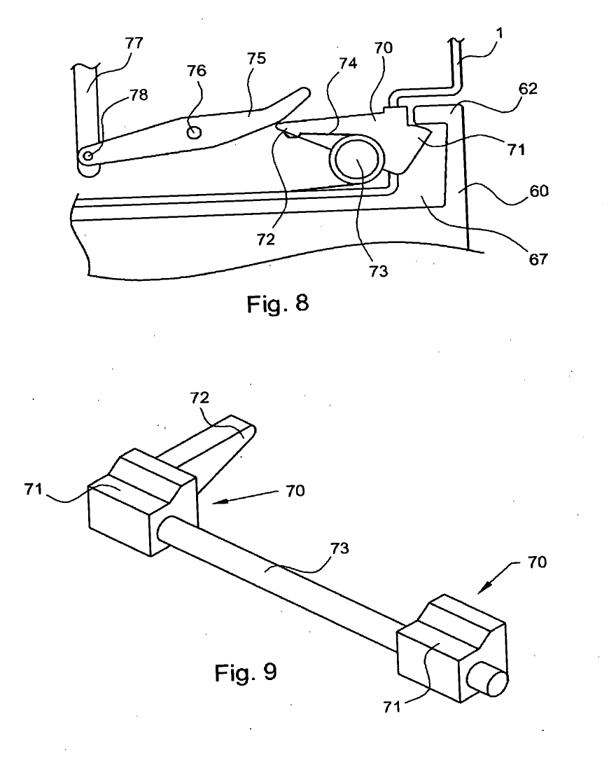

Referring to FIG. 8 there is shown a partial cross section plan view of a storage unit 10 of FIGS. 6 and 7 showing the console base unit 60 having a bin storage unit 10 mounting area 67 as well as a latching lip 62. Also shown is a bin 1 removably mounted in mounting area 67 by latching extension 71 of latch 70 being held by latching lip 62. Latch 70 is held in a latched position by latch spring 74. The latch 70 is mounted on a moveable rod 73 and is further held in a normally unlatched position by latch activating extension 72 held by activation lever 75. The activation lever 75 is mounted on a pivot pin 76 and also attached to activation handle 77 by fastener 78.

Referring now to FIG. 9 there is shown the floor-latching device of the present invention comprising a rod 73 onto each end of which is mounted a latch 70. Each latch 70 has a latching extension 71 and one of said latches 70 also has a latch activating extension 72. The rod 73 is mounted across the lower end of storage unit bin 1 thereby allowing both edges of said storage unit 10 to be locked into position in console 60.

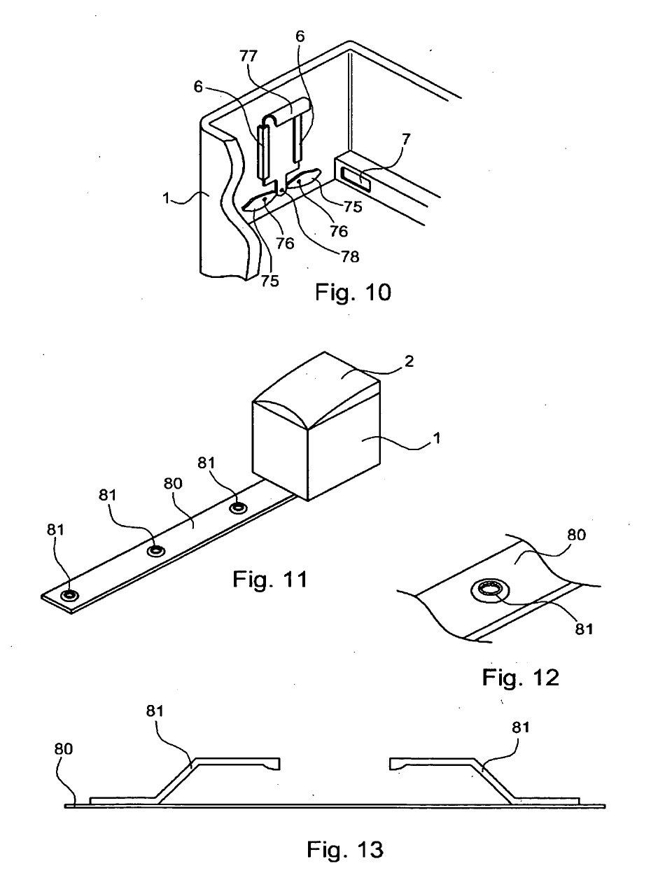

Referring to FIG. 10 there is shown a partial section of the interior of bin 1 having mounted on the interior wall thereof a pair of activation levers 75 each mounted on a pivot pin 76. One end of each of the pair of activation levers is moveably connected to activation handle 77 by fastener 78. Activation handle 77 is moveably mounted to an interior wall of bin 1 by a pair of mounting brackets 6. Also shown is opening 7 through which latch extension 71 of latch 70 passes.

FIG. 11 shows another preferred embodiment of the present invention where bin 1 having a lid 2 is mounted to a mounting strip 80 by means of one or more of a plurality of mounting ports 81. The mounting strip 80 is fixedly fastened to the floor of a vehicle by known means such as, for example, welding, screws, and rivets.

FIG. 12 shows a close-up perspective view of one of a plurality of mounting ports 81 on mounting strip 80.

FIG. 13 shows a cross section through mounting strip 80 and one of a plurality of mounting ports 81.

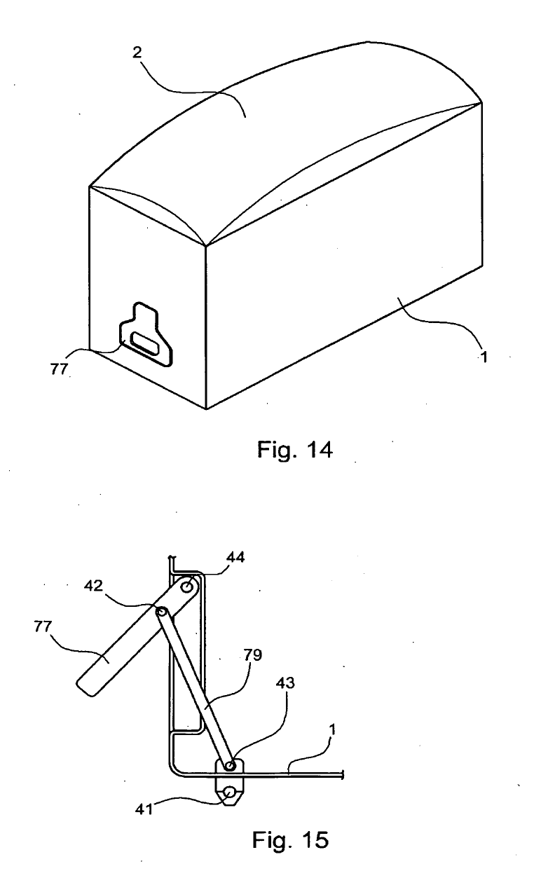

Referring to FIG. 14 there is shown a perspective view of a preferred embodiment of the storage bin 1 having a lid 2 and a activation handle 77 mounted on the exterior wall of storage bin 1.

FIG. 15 shows a partial plan view of bin 1 of FIG. 14 showing the activation handle moveably mounted in bin 1 by fastener 44 and further moveably connected to mounting pin 41 through arm 79 and fasteners 42 and 43.

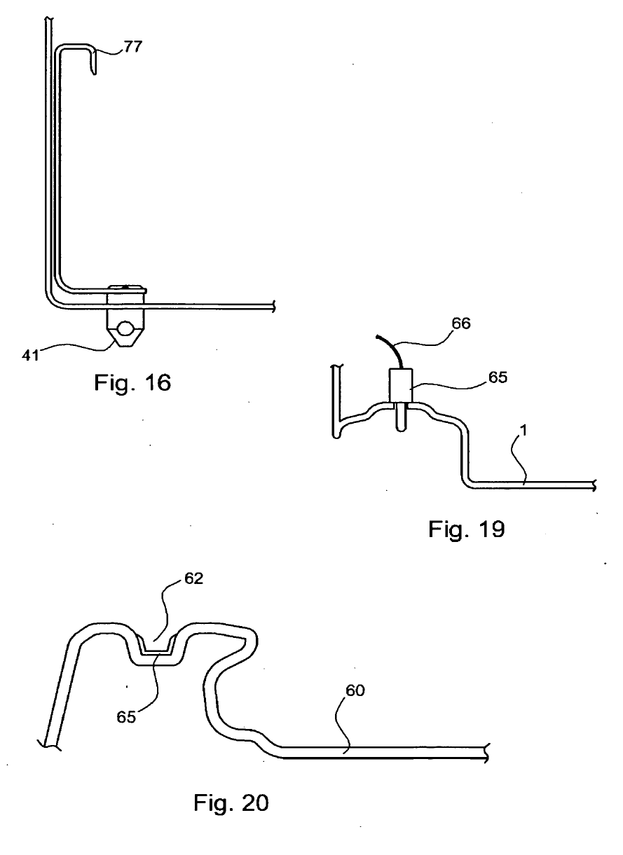

FIG. 16 shows a partial plan view of the bin 1 of FIG. 11 showing activation lever 77 mounted to mounting pin 41.

In FIG. 17 there is shown an exploded perspective view of another preferred embodiment of the present invention comprising a bin mounting unit 60 having an adjustable length bin mounting track system 61 moveably mounted therein. Also shown is a pair of bins 1 each having a lid 2 suitable for mounting in mounting unit 60 and mounting track system 61.

FIG. 18 shows a perspective view of a mounting unit 60 having a pair of mounting rails 61 and each mounting rail 61 having a power slot 62. One of said power slots 62 having a positive electrical connection point 63 and the other of said power slots 62 having a negative electrical connection point 64. Electrical connection points 63 and 64 allowing for the electrical connection of the mounting unit 60 to the vehicles electrical system.

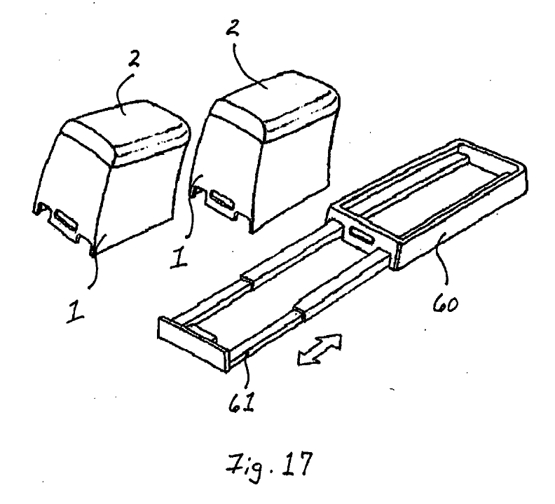

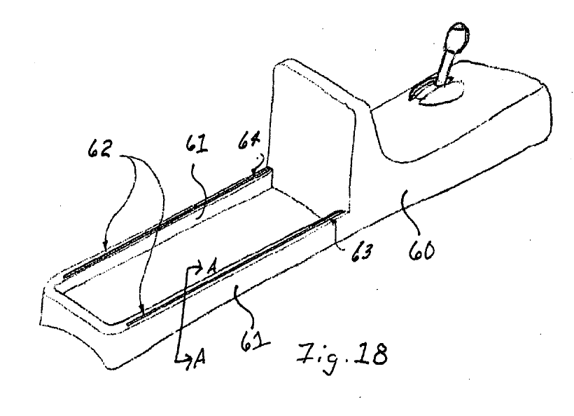

In FIG. 19 there is shown a partial plan view of FIG. 18 showing of one the pair of mounting rails 61 showing the power slot 62 having an electrical connector 65 mounted therein and running the length of the power slot 62.

Finally in FIG. 20 there is shown a partial plan view of a storage unit 10 with an electrical connector 65 mounted therein allowing connection to an electrical device.

It is also to be understood that the use of the terms “panel” and “floor” is used to encompass not only those specific areas of the interior of a vehicle but in fact any surface capable of having the present invention mounted to it.

The modular storage units 10 and 20 may be made from any suitable material well known in the art. Preferred materials are polypropylene, reinforced polypropylene, ABS, polycarbonate, polycarbonate/ABS, nylon, and polyacetal. It is to be further understood that the modular storage units 10 and 20 may be made from the same or different materials suitable for the particular application. For example the modular storage units 10 and 20 may be made from metals such as, for example, aluminum, steel, and other metals to provide greater strength for applications that may require it. It is also to be understood that the lid 2 may be hinged to the bin 1 using any suitable hinge well known in the art. Suitable hinges include, for example, living hinges, piano hinges, and the like.

Although the preferred embodiments of the present invention has been disclosed, various changes and modifications may be made without departing from the scope of the invention as set forth in the appended claims.

What is claimed is:

1. A modular floor console providing user configurable storage detachably mountable within a vehicle comprising;
at least one storage unit comprising a bin having a hinged lid mounted thereon, said bin further having a device for detachably latching said bin to a surface of a vehicle interior;
thereby providing a removable, configurable modular floor storage console.

2. The modular floor console as claimed in claim 1 wherein, said modular floor console comprises at least two interlocking storage units.

3. The modular floor console as claimed in claim 1 wherein, said at least one storage unit composition is one of polypropylene, reinforced polypropylene, ABS, polycarbonate, polycarbonate/ABS, nylon, and polyacetal.

4. A modular floor console providing user configurable storage detachably mountable within a vehicle comprising;
at least one storage unit comprising a bin having a hinged lid mounted thereon, said bin further having a device for detachably latching said bin to a surface of a vehicle interior; and
an end storage unit comprising a bin, said end storage unit further having located on one exterior end at least one interlocking prong and further having a device for detachably latching said end storage unit to a surface of a vehicle interior as well as activating the detachably latching device located on said at least one storage unit;
thereby providing a removable, configurable modular floor storage console.

5. The modular floor console as claimed in claim 4 wherein, said modular floor console comprises at least two interlocking storage units and an end unit.

6. The modular floor console as claimed in claim 4 wherein, said at least one storage unit and one end unit composition is one of polypropylene, reinforced polypropylene, ABS, polycarbonate, polycarbonate/ABS, nylon, and polyacetal.

7. A modular floor console providing user configurable storage detachably mountable within a vehicle comprising;
at least one storage unit comprising a bin having a hinged lid mounted thereon, said bin further having a device for detachably latching said bin to a surface of a vehicle interior; and
providing electrical connection through said at least one interlocking prong and said at least one complimentary interlocking channel;
thereby providing an electrically enabled, removable, configurable modular floor storage console.

8. The modular floor console as claimed in claim 7 wherein, said modular floor console comprises at least two interlocking storage units.

9. The modular floor console as claimed in claim 7 wherein, said at least one storage unit composition is one of polypropylene, reinforced polypropylene, ABS, polycarbonate, polycarbonate/ABS, nylon, and polyacetal.

10. A modular floor console providing user configurable storage detachably mountable within a vehicle comprising;
at least one storage unit comprising a bin having a hinged lid mounted thereon, said bin further having located on one exterior end at least one interlocking prong and having located on the exterior end opposite at least one complimentary interlocking channel, said bin further having a device for detachably latching said bin to a surface of a vehicle interior;
an end storage unit comprising a bin having access through a end wall and a top surface adaptable to holding beverage containers therein, said end storage unit further having located on one exterior end at least one interlocking prong and further having a device for detachably latching said end storage unit to a surface of a vehicle interior as well as activating the detachably latching device located on said at least one storage unit; and
providing electrical connection through said at least one interlocking prong and said at least one complimentary interlocking channel;
thereby providing a removable, configurable modular floor storage console.

11. The modular floor console as claimed in claim 10 wherein, said modular floor console comprises at least two interlocking storage units and an end unit.

12. The modular floor console as claimed in claim 10 wherein, said at least one storage unit and one end unit composition is one of polypropylene, reinforced polypropylene, ABS, polycarbonate, polycarbonate/ABS, nylon, and polyacetal.

13. A modular floor console providing user configurable storage detachably mountable within a vehicle comprising;
a console mountable to a vehicle floor and having a storage unit mounting area;
at least one storage unit comprising a bin having a hinged lid mounted thereon, said bin further having a device for detachably latching said bin in the storage unit mounting area of said console;
thereby providing a removable, configurable modular floor storage console.

14. The modular floor console as claimed in claim 13 wherein, said modular floor console comprises at least two interlocking storage units and an end unit.

15. The modular floor console as claimed in claim 13 wherein, said at least one storage unit and one end unit composition is one of polypropylene, reinforced polypropylene, ABS, polycarbonate, polycarbonate/ABS, nylon, and polyacetal.

16. The modular floor console as claimed in claim 13 wherein, said at least one storage unit is removably mounted in said storage unit mounting area by a latching device.

17. The modular floor console as claimed in claim 16 wherein, said latching device latches both edges of said at least one storage unit in said storage unit mounting area.

18. The modular floor console as claimed in claim 13 wherein, said at least one storage unit comprises two storage units and an end storage unit.

19. The modular floor console as claimed in claim 16 wherein, said latching device is activated by a latching handle.

20. The modular floor console as claimed in claim 13 wherein, said storage unit mounting area has at least one organizer tray removably mounted therein for use when no storage unit is covering that portion of the storage unit mounting area.

21. A modular floor console providing user configurable storage detachably mountable within a vehicle comprising;
a console mountable to a vehicle floor and having an adjustable size storage unit mounting area;
at least one storage unit comprising a bin having a hinged lid mounted thereon, said bin further having a device for detachably latching said bin in the storage unit mounting area of said console;
thereby providing a removable, configurable modular floor storage console.

22. The modular floor console as claimed in claim 21 wherein, said modular floor console comprises at least two interlocking storage units and an end unit.

23. The modular floor console as claimed in claim 21 wherein, said at least one storage unit and one end unit composition is one of polypropylene, reinforced polypropylene, ABS, polycarbonate, polycarbonate/ABS, nylon, and polyacetal.

24. The modular floor console as claimed in claim 21 wherein, said at least one storage unit is removably mounted in said storage unit mounting area by a latching device.

25. The modular floor console as claimed in claim 24 wherein, said latching device latches both edges of said at least one storage unit in said storage unit mounting area.

26. The modular floor console as claimed in claim 21 wherein, said at least one storage unit comprises two storage units and an end storage unit.

27. The modular floor console as claimed in claim 24 wherein, said latching device is activated by a latching handle.

28. The modular floor console as claimed in claim 21 wherein, said storage unit mounting area has at least one organizer tray removably mounted therein for use when no storage unit is covering that portion of the storage unit mounting area.

29. The modular floor console as claimed in claim 1 wherein, said at least one storage unit is mounted directly to a vehicle floor.

30. The modular floor console as claimed in claim 4 wherein, said at least one storage unit is mounted on a mounting strip which is permanently mounted to a vehicle floor.

31. The modular floor console as claimed in claim 7 wherein, said at least one storage unit is mounted on a mounting strip which is permanently mounted to a vehicle floor.

32. The modular floor console as claimed in claim 10 wherein, said at least one storage unit is mounted on a mounting strip which is permanently mounted to a vehicle floor.

33. The modular floor console as claimed in claim 13 wherein, said at least one storage unit is mounted on a mounting strip which is permanently mounted to a vehicle floor.

34. The modular floor console as claimed in claim 1 wherein, said at least one storage unit is mounted to a track system comprising part of said mounting strip.

35. The modular floor console as claimed in claim 4 wherein, said at least one storage unit is mounted to a track system comprising part of said mounting strip.

36. The modular floor console as claimed in claim 7 wherein, said at least one storage unit is mounted to a track system comprising part of said mounting strip.

37. The modular floor console as claimed in claim 10 wherein, said at least one storage unit is mounted to a track system comprising part of said mounting strip.

38. The modular floor console as claimed in claim 13 wherein, said at least one storage unit is mounted to a track system comprising part of said mounting strip.
